(19) United States
(12) Patent Application Publication
(10) Pub. No.: US 2010/0294784 A1
(43) Pub. Date: Nov. 25, 2010

(54) Extruded port for a pressure vessel and method of manufacture thereof

(75) Inventor: Truman G. Johnson, Urbana, OH (US)

Correspondence Address: MARK A. NAVARRE, P.O. BOX 537, URBANA, OH, 43078, US

(73) Assignee: Johnson Welded Products, Inc.

(21) Appl. No.: 12/800,513

(22) Filed: May 17, 2010

Related U.S. Application Data
(60) Provisional application No. 61/216,590, filed on May 19, 2009.

(51) Int. Cl. B65D 6/40; B31B 1/74

(52) U.S. Cl. 220/661; 493/82

(57) ABSTRACT

A pressure vessel is provided with one or more integral pressure ports formed by extrusion of the pressure vessel wall. The portion of the vessel to receive the port is drilled or punched to form an opening into which an extrusion tool is inserted. The inner periphery of the vessel surrounding the opening is backed-up by a cylindrical die, and the extrusion tool is pressed into the die to extrude a marginal portion of the vessel material surrounding the opening into the die to form an integral internal sleeve with an O-ring seal area, and to form straight threads in the extruded sleeve by roll-deformation. The pressure ports can be formed in the body or end-caps of the pressure vessel, and the portion of the vessel to receive a port may be locally flattened prior to formation of the port.

### RELATED APPLICATIONS

This application claims the benefit of provisional U.S. Patent Application Ser. No. 61/216,590, filed May 19, 2009.

### TECHNICAL FIELD

The present invention relates to pressure vessels for storing liquid or gaseous substances under pressure, and more particularly to the formation of a threaded port or fitting for such a vessel.

### BACKGROUND OF THE INVENTION

Vessels that store liquid or gaseous substances are provided with one or more ports or fittings for filling the vessel and delivering the stored substance to other devices. For example, heavy-duty motor vehicles are typically equipped with one or more welded air pressure tanks having an input port for receiving pressurized air from an engine-driven compressor, and one or more output ports for delivering pressurized air to various pneumatically-controlled brake cylinders.

Although plug-in fittings have been available for usage in pressure vessels, most pressure vessel ports are configured to provide a threaded connection between the pressure vessel and a pressure pipe because threaded connections are easily removed for maintenance and repair work. However, threaded connections tend to leak, particularly in the case of tapered pipe threads that rely on the metal-to-metal contact of the threads to seal the connection.

The customary way of forming a threaded pressure port is to manufacture a separate threaded part such as a metal ferrule that is partially inserted into an opening formed in the pressure vessel, and then welded to the exterior surface of the pressure vessel. While this process can be performed effectively, it necessarily involves the manufacture of an additional part (i.e., the metal ferrule) and a considerable amount of skilled or semi-skilled labor to weld the ferrule to the pressure vessel, and then test the pressure vessel for leakage at the weld joint.

Accordingly, what is needed is an improved way of forming a threaded pressure port that is both leak-proof and relatively inexpensive to manufacture.

### SUMMARY OF THE INVENTION

The present invention is directed to an improved pressure vessel having an integral threaded pressure port that is formed by extrusion. The portion of the vessel to receive the port is drilled or punched to form a small opening into which an extrusion tool is inserted. The inner periphery of the vessel surrounding the opening is backed-up by a cylindrical die, and the extrusion tool is pressed into the die to extrude a marginal portion of the vessel material surrounding the opening into the die to form an integral internal sleeve with an O-ring seal area, and to form straight threads in the extruded sleeve by roll-deformation. Pressure ports according to this invention can be formed in the body or end-caps of a pressure vessel, and the portion of the vessel to receive the port may be locally flattened prior to formation of the port.

### BRIEF DESCRIPTION OF THE DRAWINGS

FIG. 1 is an isometric view of a cylindrical pressure vessel having a plurality of extruded and threaded end-cap pressure ports according to this invention;

FIG. 2 is a cross-sectional view of the pressure vessel end-cap of FIG. 1;

FIG. 3 depicts in partial cross-section the formation of an extruded and threaded pressure port with an extrusion tool and die according to this invention;

FIG. 4 is a cross-sectional view of the completed pressure port of FIG. 3; and

FIG. 5 is a cross-sectional view of a pressure port formed on a curved surface of the pressure vessel of FIG. 1.

### DESCRIPTION OF THE PREFERRED EMBODIMENT

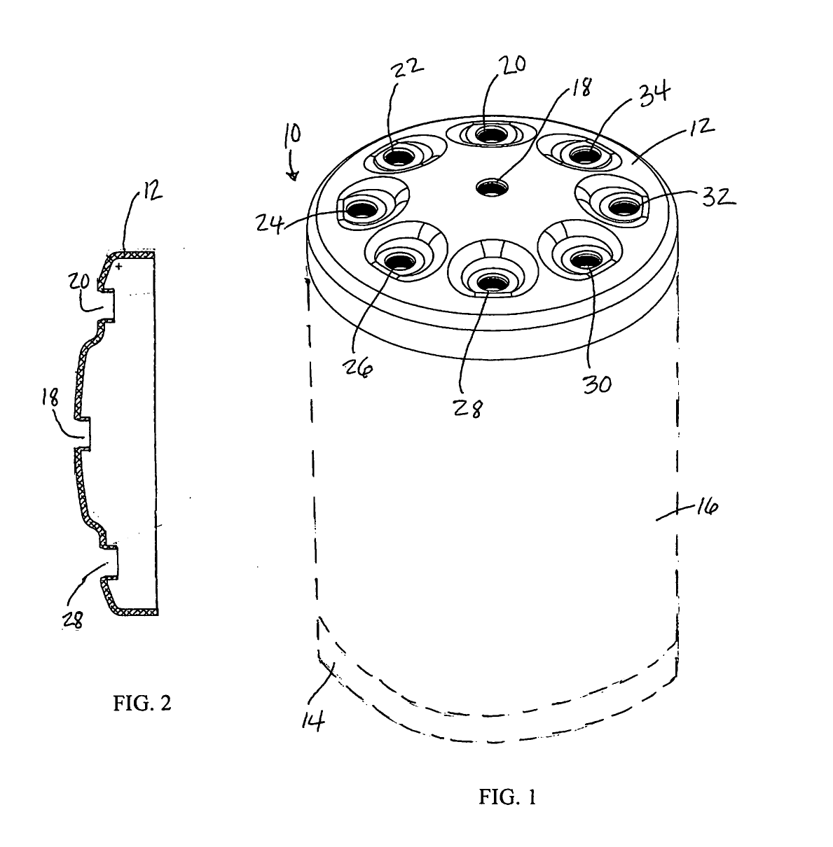

Referring to the drawings, and particularly to FIGS. 1-2, the reference numeral 10 generally designates a cylindrical pressure vessel formed by welding end-caps 12, 14 to a cylindrical sidewall 16. In the illustration, a set of nine threaded pressure ports 18, 20, 22, 24, 26, 28, 30, 32, 34 are formed in the end cap 12. The sidewall 16 and end cap 14 are shown in phantom because the pressure ports 18-34 are formed in end cap 12 prior to welding end cap 12 to the cylindrical sidewall 16. However, it will be understood that the end cap 12 may be welded to the sidewall 16 prior to formation of the threaded pressure ports 18-34, provided there is access to the inner periphery of the end cap 12. It should be additionally be understood that the pressure ports of this invention may be formed on the vessel's sidewall 16, if desired, and that the number and placement of the pressure ports may vary depending on the application.

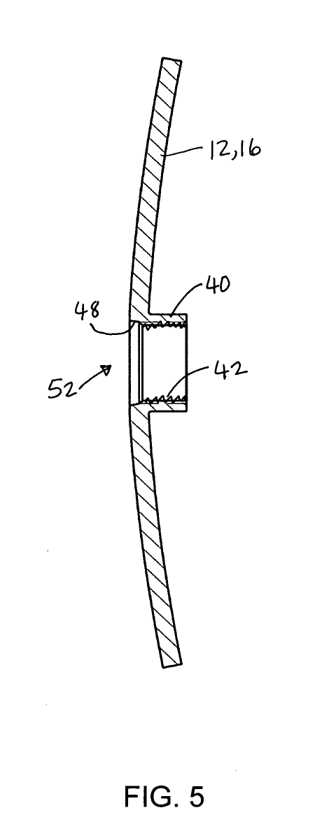

As shown most clearly in the cross-sectional view of FIG. 2, the end cap 12 is domed and locally flattened in the regions where the pressure ports are to be formed, with the exception of the center pressure port 18. Locally flattening the port regions prior to formation of the ports can be significant from a manufacturing standpoint because it allows one or more of the processing steps in the formation of the pressure ports 18-34 to be carried out simultaneously with a set of tools that are advanced in parallel by a multi-tool machine. In the case of center pressure port 18, localized flattening is not required because the centerline of port 18 is normal to the radius of curvature of vessel 10 at that point. In other words, pressure ports according to this invention are formed either normal to a localized flattened area, or normal to the radius of curvature of the vessel 10 at that point; and localized flattening can be useful because it locally eliminates the vessel's radius of curvature, allowing one or more of the processing steps in the formation of the multiple pressure ports to be carried out concurrently with a set of tools that are advanced in parallel. Nevertheless, certain applications or end-users may require pressure ports that are normal to the vessel's radius of curvature, and in that case, the pressure ports 18-34 may be formed individually, with no preliminary localized flattening. An example of such an implementation is depicted in FIG. 5, where the reference numeral 52 designates a pressure port formed in the vessel's end cap 12 or sidewall 16.

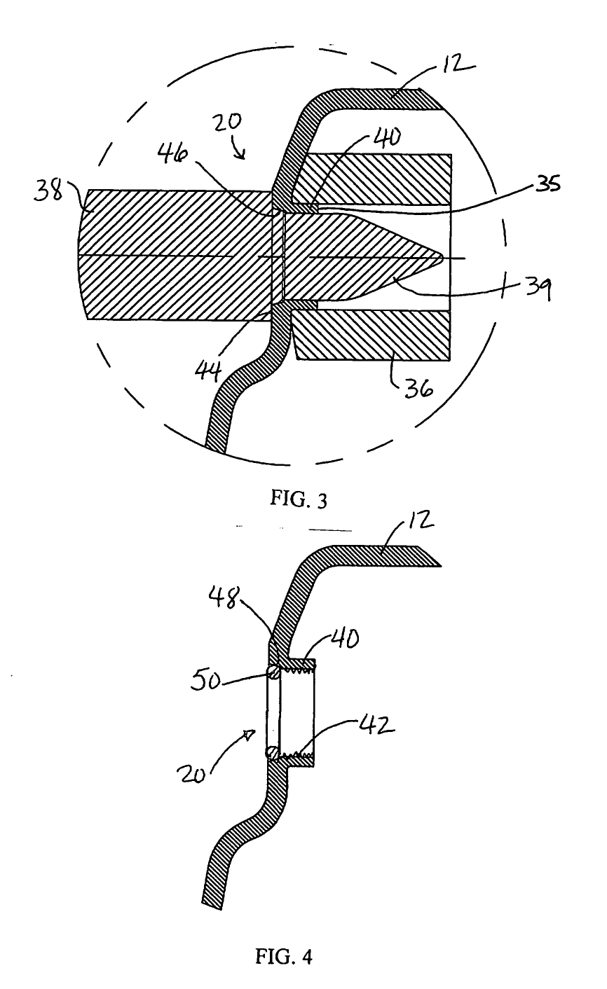

Apart from the presence or absence of preliminary localized flattening of the pressure vessel 10, each of the pressure ports 18-34 is formed by the same process, illustrated in FIG. 3 in respect to the M22 pressure port 20. Referring to FIG. 3, the process involves making a small opening 35 in the end cap 12, backing-up the inner periphery of the end cap 12 with a cylindrical die 36 centered with respect to the small opening 35, and pressing an extrusion tool 38 through the opening 35 and into the die 36. The tapered head 39 of extrusion tool 38 extrudes a marginal portion of the end cap material surrounding the small opening 35 into the die 38 to form an integral internal sleeve 40, and to form straight threads 42 in the inner periphery of sleeve 40 by roll-deformation. Thus, the die 36 serves to back-up both the inner periphery of the end cap 12 and the outer periphery of the sleeve 40. The extrusion tool 38 has a shoulder 44 that engages the exterior periphery of the end cap 12 when fully inserted, and the tool portion 46 immediately adjacent the shoulder 44 tapers inwardly to form a tapered sealing surface 48 at the rim of the port opening, as seen in FIG. 4. As also indicated in FIG. 4, the tapered sealing surface 48 is configured to accept an O-ring 50 that seals the vessel 10 to a threaded conduit (not shown) coupled to the pressure port 20. The process is completed by removing the extrusion tool 38 and die 36, yielding the completed pressure port 20 of FIG. 4.

In the illustrated embodiments, the end caps 12, 14 and sidewall 16 of vessel 10 are formed of aluminum, with a nominal end cap thickness of 0.190 inch. The initial opening 35 in end cap 12 is 0.437 inch, and the typical outer diameter of the sleeve 40 is 1.027 inch. The sleeve 40 is extruded to a depth of 0.31 inch while preserving an adequate sleeve wall thickness. In general however, it will be understood that pressure ports according to this invention may be formed in pressure vessels constructed of other extrudable materials such as steel, brass, or even plastic, depending on pressure rating and usage. In cases where the vessel wall thickness in insufficient to result in adequate sleeve wall thickness, a shoulder or buttress of additional material may be fitted over the sleeve 40 and welded or otherwise attached to the sleeve 40 and/or the inner periphery of vessel 10.

In summary, the present invention provides a reliable and low-cost process of forming threaded pressure ports in an extrudable wall of a pressure vessel. The pressure ports so formed are integral with the pressure vessel wall so that there are no welds to test and/or re-work. Additionally, the combination of straight threads and O-ring sealing ensures leak-proof couplings, and no separately manufactured parts such as threaded ferrules are required. While the present invention has been described with respect to the illustrated embodiments, it is recognized that numerous modifications and variations in addition to those mentioned herein will occur to those skilled in the art. For example, the extrusion and roll deformation portions of the described process may be carried out with separate tools, the vessel 10 may be used for storing substances at atmospheric or sub-atmospheric pressures, and so forth. Accordingly, it is intended that the invention not be limited to the disclosed embodiment, but that it have the full scope permitted by the language of the following claims.

1. A pressure vessel having a pressure port formed therein, the improvement wherein:
the pressure port is formed by producing an opening in a wall of the pressure vessel, extruding a marginal portion of the wall surrounding the opening into an inner periphery of the vessel to form an internal sleeve, and forming straight threads in an inner periphery of the internal sleeve by roll-deformation.

2. The pressure vessel of claim 1, where the wall of the pressure vessel is non-planar, and where:
the marginal portion of the wall surrounding the opening is extruded into the inner periphery of the vessel normal to a curvature of the pressure vessel at the location of said opening.

3. The pressure vessel of claim 1, where the wall of the pressure vessel is non-planar, and where:
the pressure port is formed in a region of the pressure vessel wall that has been locally flattened.

4. The pressure vessel of claim 1, where:
a rim of the internal sleeve has a tapered sealing surface for accepting an O-ring seal.

5. A method of forming a pressure port in a wall of a pressure vessel, comprising the steps of:
forming an opening in the wall of the pressure vessel;
backing-up an inner periphery of the pressure vessel wall with a cylindrical die centered with respect to the opening;
pressing an extrusion tool through the opening and into the die to extrude a marginal portion of the vessel wall surrounding the opening into the die to form an internal sleeve that is integral with the pressure vessel wall; and
forming straight threads in an inner periphery of the internal sleeve by roll-deformation.

6. The method of claim 5, including the step of:
forming said straight threads with said extrusion tool.

7. The method of claim 5, where the wall of the pressure vessel is non-planar, and the method includes the step of:
preliminarily flattening a region of the pressure vessel wall in which the opening is formed.

8. The method of claim 5, where the wall of the pressure vessel is non-planar, and where:
the extrusion tool is pressed through the opening normal to a curvature of the pressure vessel at the location of said opening.

9. The method of claim 5, where:
the extrusion tool forms a tapered sealing surface at a rim of said internal sleeve for accepting an O-ring seal.

10. The method of claim 5, where:
said cylindrical die backs-up the inner periphery of the pressure vessel wall and an outer periphery of said internal sleeve.
